(19) United States
(12) Patent Application Publication
(10) Pub. No.: US 2025/0297752 A1
(43) Pub. Date: Sep. 25, 2025

(54) FACILITY MANAGEMENT SYSTEM, NOTIFICATION APPARATUS, AND PROGRAM

(71) Applicant: Mitsubishi Electric Corporation, Tokyo (JP)

(72) Inventors: Kanta MIYAMOTO, Tokyo (JP); Koki OMATA, Tokyo (JP); Saki MIYAI, Tokyo (JP); Taichi ISHIZAKA, Tokyo (JP)

(21) Appl. No.: 18/867,528

(22) PCT Filed: Jun. 9, 2022
(86) PCT No.: PCT/JP2022/023306

§ 371 Date: Nov. 20, 2024

(51) Int. Cl. F24F 11/38; F24F 11/52

(52) U.S. Cl. CPC F24F 11/38; F24F 11/52

(57) ABSTRACT

A management server generates abnormality information on an abnormal facility device of at least one facility device managed by an identified management apparatus indicated by identification information transmitted from a user terminal. The management server then causes the user terminal to provide notification of this abnormality information.

### TECHNICAL FIELD

The present disclosure relates to a facility management system, a notification apparatus, and a program.

### BACKGROUND ART

Japanese Patent No. 4518208 (PTL 1) discloses a management system to manage an air-conditioner. This management system is provided in a structure such as a building. This management system includes a remote management apparatus, a service terminal, a local controller, a plurality of air-conditioners, and a plurality of sensors. The service terminal is a terminal of a serviceperson who repairs and remedies the air-conditioners. The local controller manages the plurality of air-conditioners. The plurality of sensors detect physical quantities (a temperature, a pressure, and the like) of the air-conditioners.

The local controller detects abnormality of the plurality of air-conditioners based on the physical quantities detected by the plurality of sensors. When the local controller detects abnormality, it transmits an abnormality signal indicating detection of the abnormality to the remote management apparatus. When the remote management apparatus receives the abnormality signal, it causes the service terminal to provide notification of occurrence of abnormality of the air-conditioner. A serviceperson recognizes abnormality of the air-conditioner through the notification.

### CITATION LIST

### Patent Literature

PTL 1: Japanese Patent No. 4518208

### SUMMARY OF INVENTION

### Technical Problem

A user in the structure where the management system is provided may feel abnormality of a facility device such as an air-conditioner and may desire to know about the abnormality of the facility device. The management system described above, however, may be disadvantageous in that it does not consider such a case.

The present disclosure was made to solve such a problem, and an object thereof is to provide a technique to allow a user to appropriately recognize abnormality of a facility device.

### Solution to Problem

A management system in the present disclosure includes first management apparatuses and a second management apparatus. Each first management apparatus of the first management apparatuses manages a facility device including at least one air-conditioner. The second management apparatus communicates with the first management apparatuses and a user terminal. The user terminal accepts input from a user. The user terminal is configured to transmit identification information of the first management apparatuses to the second management apparatus in accordance with the input from the user. The second management apparatus is configured to generate abnormality information on an abnormal facility device among facility devices each including the at least one air-conditioner managed by an identified management apparatus indicated by the identification information. The second management apparatus is configured to cause the user terminal to provide notification of the abnormality information.

A management system in the present disclosure includes management apparatuses. Each management apparatus of the management apparatuses manages a facility device including at least one air-conditioner. The management apparatus is configured to communicate with a user terminal to accept input from a user. The user terminal is configured to transmit a prescribed signal to the management apparatus indicated by identification information designated in accordance with the input from the user. The management apparatus that has received the prescribed signal is configured to obtain abnormality information on an abnormal facility device of at least one facility device managed by the management apparatuses. The management apparatus is configured to then cause the user terminal to provide notification of the abnormality information.

A notification apparatus in the present disclosure includes a communication interface and a processor. The communication interface is configured to communicate with a user terminal configured to accept input from a user. Each of management apparatuses is configured to manage at least one facility device. Identification information is defined for each of the management apparatuses. The communication interface is configured to receive the identification information transmitted from the user terminal in accordance with the input from the user. The processor is configured to generate abnormality information on an abnormal facility device of the at least one facility device managed by an identified management apparatus indicated by the identification information. The processor is configured to cause the user terminal to provide notification of the abnormality information.

A management method in the present disclosure includes transmitting, by a user terminal, when the user terminal accepts input from a user, identification information of any management apparatus of management apparatuses each configured to manage a facility device including at least one air-conditioner. In addition, the management method includes providing, by the user terminal, notification of abnormality information on an abnormal facility device among facility devices each including the at least one air-conditioner managed by an identified management apparatus indicated by the identification information.

A management method in the present disclosure includes starting up, by a user terminal, an application in response to a prescribed operation performed onto the user terminal. The management method includes transmitting input information to a management apparatus by the user terminal when the user terminal accepts the input information, the input information relating to a facility device including an air-conditioner. The management method includes determining, by the management apparatus, in accordance with the input information, whether to generate abnormality information on an abnormal facility device among facility devices or to cause a prescribed apparatus to provide notification of the input information. The management method includes providing, by the user terminal, notification of the abnormality information when the abnormality information is generated.

A program in the present disclosure causes a computer to perform following processes. The computer is configured to communicate with first management apparatuses and a second management apparatus, each first management apparatus being configured to manage a facility device including at least one air-conditioner. The processes include accepting input from a user. The processes include transmitting identification information of the first management apparatuses to the second management apparatus when the input is accepted. In addition, the processes include providing notification of abnormality information from the second management apparatus that has obtained the abnormality information, the abnormality information being information on an abnormal facility device of at least one facility device managed by an identified management apparatus indicated by the identification information.

### Advantageous Effects of Invention

According to the present disclosure, the user can appropriately recognize abnormality of the facility device.

### BRIEF DESCRIPTION OF DRAWINGS

FIG. 1 is a diagram showing an exemplary configuration of a management system according to a first embodiment.

FIG. 2 is a diagram showing an exemplary hardware configuration of a management server and the like.

FIG. 3 is a functional block diagram of a facility management apparatus.

FIG. 4 is a diagram schematically showing an exemplary facility device DB.

FIG. 5 is a functional block diagram of the management server.

FIG. 6 is a diagram schematically showing an exemplary facility management apparatus DB.

FIG. 7 is a diagram schematically showing an exemplary service company DB.

FIG. 8 is a functional block diagram of a user terminal.

FIG. 9 is a functional block diagram of a service terminal.

FIG. 10 is a diagram showing an exemplary chat screen.

FIG. 11 is a diagram showing an exemplary chat screen.

FIG. 12 is a diagram showing an exemplary chat screen.

FIG. 13 is a diagram showing an exemplary chat screen.

FIG. 14 is a flowchart of the management system.

FIG. 15 is a flowchart of the management system.

FIG. 16 is a diagram showing an exemplary configuration of a management system in a second embodiment.

FIG. 17 is a flowchart of a management system in a third embodiment.

### DESCRIPTION OF EMBODIMENTS

The present embodiment will be described in detail below with reference to the drawings. The same or corresponding elements in the drawings have the same reference characters allotted and description thereof will not be repeated.

### First Embodiment.

### Configuration of Management System

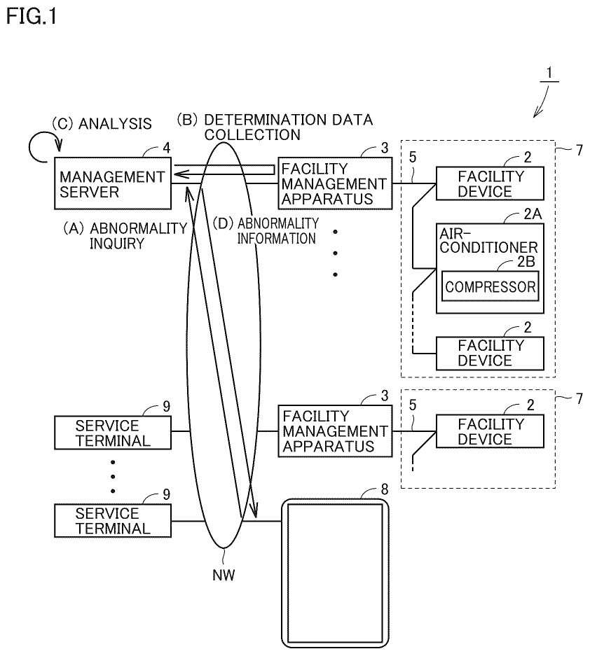

FIG. 1 is a diagram for illustrating a configuration of a management system 1 according to a first embodiment. As shown in FIG. 1, management system 1 according to the first embodiment includes a plurality of facility management apparatuses 3, a management server 4, and a service terminal 9. The example in FIG. 1 shows a user terminal 8 and a plurality of facility devices 2. Management system 1 may include at least one of user terminal 8 and the plurality of facility devices 2.

Facility management apparatus 3 corresponds to the “first management apparatus” in the present disclosure and management server 4 corresponds to the “second management apparatus” or the “notification apparatus” in the present disclosure. For the plurality of facility devices 2, identification information (a facility device identification (ID) below for identification of facility devices 2 is defined. For the plurality of facility management apparatuses 3, identification information (a facility management apparatus ID below) for identification of facility management apparatuses 3 is defined.

Facility management apparatuses 3, user terminal 8, management server 4, and service terminal 9 are communicatively connected over a network NW. Network NW may be the Internet. Network NW may be a local area network (LAN) in which management server 4 and facility management apparatuses 3 are connected within an identical location. Alternatively, network NW may be a closed circuit network where connection is established via a virtual private network (VPN) router.

The plurality of facility devices 2 are provided at prescribed locations in a structure. Facility devices 2 include, for example, an air-conditioning device, a ventilation device, a lighting device, or the like. The example in FIG. 1 shows an air-conditioner 2A by way of example of the facility device. Air-conditioner 2A includes a compressor 2B. Facility device 2 may be another device.

Facility device 2 and facility management apparatus 3 are communicatively connected to each other through a dedicated communication line 5. Facility management apparatus 3 manages at least one facility device 2. In other words, at least one facility device 2 operates under management by facility management apparatus 3. Notification of determination data which will be described later is provided from facility device 2 to facility management apparatus 3 through dedicated communication line 5. “Notification” in the present disclosure may be provided by any method so long as it is the method for recognition by a user or the like. For example, the notification is notification by representation of an image on a display apparatus or notification by output of sound from a speaker. In the present disclosure, a configuration in which notification is provided by representation of an image on a display apparatus will mainly be described.

The determination data includes operation data or the like. The plurality of facility devices 2 are provided with a detector (not shown) to detect a physical quantity. The detector is a pressure sensor or a temperature sensor. Operation data (physical quantity) obtained by the detector which is the pressure sensor represents a pressure value. Operation data (physical quantity) obtained by the detector which is the temperature sensor represents a temperature. At least one facility device 2 connected to (managed by) one facility management apparatus 3 will also be referred to as a “facility device group 7” below. Facility device group 7 includes at least one air-conditioner 2A,

For each of the plurality of facility management apparatuses 3, identification information for identification of facility management apparatus 3 is defined. The identification information is, for example, a production number of facility management apparatus 3. The identification information may be another type of information.

Another type of information may be, for example, an installation location where facility management apparatus 3 is provided. The installation location is, for example, such information as “C area on Bth floor of A building.”

Typically, facility management apparatus 3 and facility device group 7 managed by facility management apparatus 3 are provided in one structure. A plurality of facility management apparatuses 3 and facility device group 7 managed by the plurality of facility management apparatuses 3 may be provided in one structure.

Management server 4 can communicate with user terminal 8, service terminal 9, and the plurality of facility management apparatuses 3 over network NW. Management server 4 manages a plurality of facility management apparatuses 3.

User terminal 8 is a terminal apparatus owned by a user. The “user” here includes a user of a structure, a manager of a structure, a resident in a structure, and the like. User terminal 8 is typically a portable terminal that can be carried by the user. The portable terminal is, for example, a smartphone, a tablet, or the like. User terminal 8 may be, for example, a stationary terminal (for example, a desktop personal computer). Alternatively, user terminal 8 may be a dedicated computer terminal.

Service terminal 9 is, for example, a terminal owned by a service company of a structure. In the present embodiment, services include repair, remedy, and maintenance of facility device 2. A serviceperson of the service company performs services (repair, remedy, and the like) of facility device 2.

Overview of the present disclosure will now be described with reference to matters in steps (A) to (D) in FIG. 1. For example, a user in a structure is assumed to feel abnormality of facility device 2. For example, a case of feeling of abnormality of facility device 2 refers, for example, to a case where the user feels a poor degree of air-conditioning by air-conditioner 2A which represents the facility device. In this case, the user provides user input onto user terminal 8. In the step (A), user terminal 8 outputs an abnormality inquiry signal to management server 4 in response to the user input. The abnormality inquiry signal includes the identification information (for example, a production number) of facility management apparatus 3. The identification information of facility management apparatus 3 may directly be inputted as the user input. Alternatively, the user input may be input of information different from the identification information, and when the information is inputted, the identification information may be outputted from user terminal 8 to management server 4 as the user input.

Then in the step (B), management server 4 requests determination data (transmits a request signal) to facility management apparatus 3 identified by the identification information included in the abnormality inquiry signal. Facility management apparatus 3 identified by the identification information will also be referred to as an “identified management apparatus” below.

The determination data is information for determination by management server 4, as to abnormality of at least one facility device managed by facility management apparatus 3. The determination data includes, for example, operation data, abnormality data, and operation history data. In the step (B), facility management apparatus 3 requested to provide the determination data transmits the determination data to management server 4.

In the step (C), management server 4 analyzes the transmitted determination data to generate abnormality information (an analysis result) on abnormality of facility device 2. Though the abnormality information will be described later, it indicates whether or not there is abnormality of facility device 2 or the like. Then in the step (D), management server 4 transmits the analysis result (whether or not there is abnormality) to user terminal 8. User terminal 8 shows (provides notification of) the abnormality information. Therefore, the user can appropriately recognize abnormality of facility device 2.

### Hardware Configuration of Management Server etc.

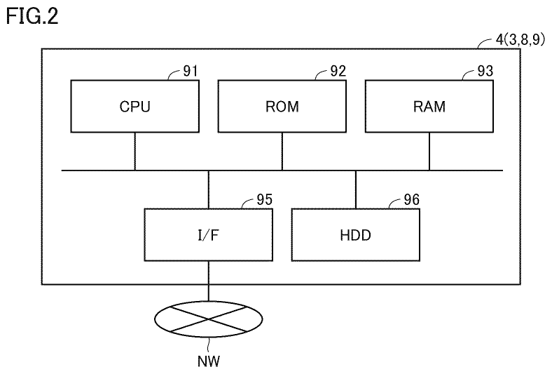

FIG. 2 is a diagram showing an exemplary hardware configuration of management server 4. Referring to FIG. 2, management server 4 includes, as main constituent elements, a central processing unit (CPU) 91, a read only memory (ROM) 92, a random access memory (RAM) 93, a hard disk drive (HDD) 96, and a communication interface (I/F) 95. The constituent elements are connected to one another through a data bus.

Communication I/F 95 is an interface for communication with another external apparatus (facility management apparatus 3, service terminal 9, and user terminal 8) over network NW. A program to be executed by CPU 91 is stored in ROM 92. Data generated by execution of a program by CPU 91 and data inputted through communication I/F 95 can temporarily be stored in RAM 93. RAM 93 can function as a temporary data memory to be used as a work area. HDD 96 is a non-volatile storage. Instead of HDD 96, a semiconductor storage such as a flash memory may be adopted.

A program stored in ROM 92 may be distributed as a program product as being stored in a non-transitory recording medium. The recording medium is a computer readable medium. Alternatively, the program may be provided as a product program that can be downloaded by an information provider through what is called the Internet. Management server 4 reads a program provided by the recording medium or the Internet. Management server 4 stores the read program in a prescribed storage area (for example, ROM 92). CPU 91 performs processing in the present disclosure by executing the program.

The configuration in FIG. 2 is also applicable to facility management apparatus 3, user terminal 8, and service terminal 9. In particular, as described with reference to the steps (A) to (D) in FIG. 1, user terminal 8 provides a user with a function to show whether or not there is abnormality of facility device 2 in response to input from the user. User terminal 8 can provide the user with this function by downloading of this application (program). This application is a chat application as will be described later. In addition, the communication I/F corresponds to a communication unit in a functional block diagram which will be described later. Input from the user may be manual input or audio input.

### Functional Block Diagram of Each Apparatus

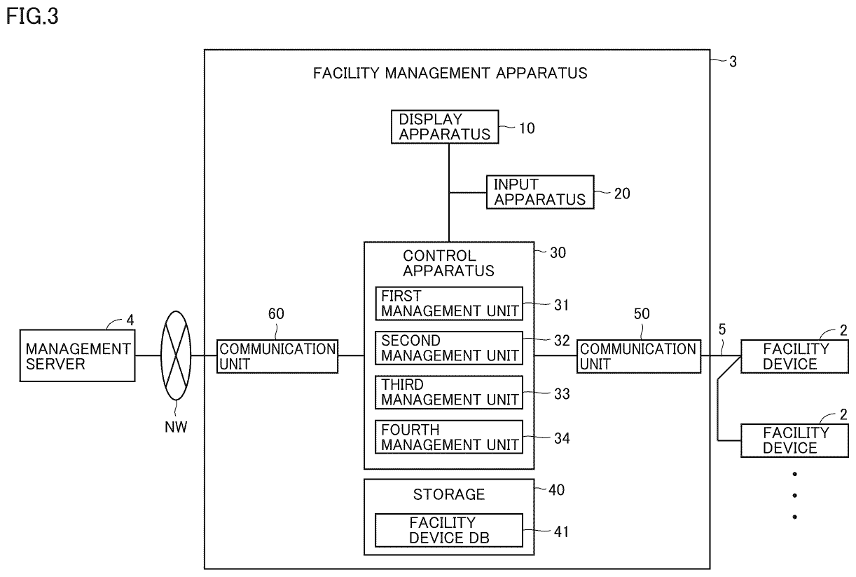

A functional block diagram of each apparatus will now be described. FIG. 3 is a functional block diagram of facility management apparatus 3. Facility management apparatus 3 includes a display apparatus 10, an input apparatus 20, a control apparatus 30, a storage 40, a communication unit 50, and a communication unit 60,

Display apparatus 10 shows various screens for management (monitoring and control) of facility device group 7 under the control by control apparatus 30. Input apparatus 20 is an input device such as a mouse, a keyboard, a touch panel, or the like. When the touch panel is adopted as input apparatus 20, input apparatus 20 is integrated with display apparatus 10. When a manager operates input apparatus 20, switching among screens, operation of the facility device, or the like can be performed depending on contents of the operation.

Control apparatus 30 manages an operating state of facility device 2. Control apparatus 30 transmits determination data requested from management server 4, in response to a command from user terminal 8. The determination data includes at least one of operation data, abnormality data, various types of history data (an abnormality history, an operation history, and the like), log data (communication data, an abnormality log, and the like), and the like. In the present embodiment, the determination data is operation data, abnormality data, and operation history data.

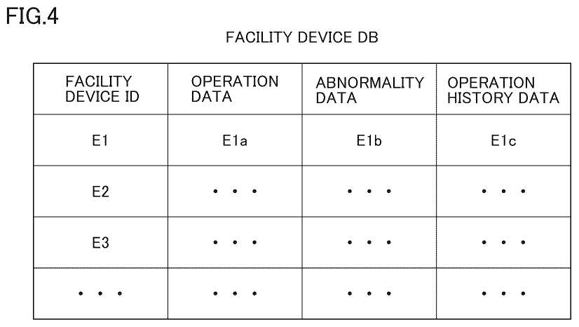

Control apparatus 30 includes a first management unit 31, a second management unit 32, a third management unit 33, and a fourth management unit 34. First management unit 31 manages (monitors or controls) the operating state of facility device 2. First management unit 31 updates at regular time intervals, the operation data and various types of data in a facility device database (DB) 41 in FIG. 4 which will be described later.

In the present embodiment, when abnormality of facility device 2 occurs, facility device 2 itself detects the abnormality. A control apparatus (not shown) of facility device 2 detects the abnormality. For example, a control apparatus of air-conditioner 2A detects leakage of refrigerant filled therein based on a pressure value and a temperature value at each portion of air-conditioner 2A. In a modification, facility management apparatus 3 may detect abnormality.

When facility device 2 detects abnormality, facility device 2 notifies facility management apparatus 3 to manage facility device 2, of the facility device ID of facility device 2 and occurrence of abnormality.

Second management unit 32 manages a state of connection to management server 4. In the present embodiment, facility management apparatus 3 and management server 4 are always connected to each other, Management server 4 that has received the abnormality inquiry signal (see the step (A) in FIG. 1) allows collection of the determination data of all facility devices 2 managed by facility management apparatus 3.

Third management unit 33 analyzes a request command (see the step (B) in FIG. 1) from management server 4. Third management unit 33 reads requested data from facility device DB 41 and transmits the data as the determination data. In a modification, third management unit 33 may receive an investigation command from management server 4. The investigation command is a command for investigation of the operating state, an abnormal state, and the like of facility device 2 (that is, the determination data described above). Third management unit 33 transfers the investigation command to facility device 2. Third management unit 33 then sends a response from facility device 2 back to management server 4.

When management server 4 determines in an abnormality inquiry from user terminal 8 that low-load operation which will be described later can be performed, management server 4 transmits a command signal indicating the low-load operation to facility management apparatus 3. When fourth management unit 34 receives the command signal, it causes facility device 2 which is to perform the low-load operation to perform the low-load operation.

Communication unit 50 is an interface for dedicated communication line 5. Facility management apparatus 3 communicates with facility device 2 through communication unit 50. Dedicated communication line 5 does not necessarily have to be a dedicated communication line, but may be a LAN interface, an RS-485 interface, or the like which is a general-purpose communication line. Communication unit 60 is connected to network NW. Facility management apparatus 3 communicates with management server 4 over network NW.

FIG. 4 is a diagram schematically showing an exemplary facility device DB 41. In the example in FIG. 4, operation data, abnormality data, and operation history data are brought in correspondence with the facility device ID.

The operation data is data indicating a current operating state of facility device 2. The operation data includes, for example, data indicating whether or not operation is currently performed. When facility device 2 is an air-conditioner, the operation data is data indicating at least one of which of a cooling mode and a heating mode is set, a pressure value and a temperature value of a prescribed portion, a setting temperature, a temperature in a room, and the number of rotations of compressor 2B. The operation data is transmitted to facility management apparatus 3 every prescribed period, and facility management apparatus 3 updates the operation data in facility device DB 41 to the latest operation data.

The abnormality data includes occurrence of abnormality, contents of the abnormality, and the like. The abnormality data includes the operation data described above at the time of occurrence of abnormality and the operation data for a certain period before occurrence of the abnormality. The abnormality may include not only abnormality of facility device 2 itself but also poor connection over the network between facility devices 2. The contents of abnormality are defined, for example, by an abnormality code. The abnormality code is typically represented by a four-digit integer. The abnormality data is transmitted from facility device 2 to facility management apparatus 3, for example, when facility device 2 detects abnormality thereof. Facility management apparatus 3 updates the abnormality data in facility device DB 41 to the latest abnormality data.

The operation history data is data indicating information on past operations performed by the user or the like onto facility device 2. For example, for air-conditioner 2A, the operation history data is data indicating a turn-on and turn-off command, an operation mode change command, a setting temperature change command, and the like. The operation history data is transmitted from facility device 2 to facility management apparatus 3 when facility device 2 detects operation thereonto. Facility management apparatus 3 updates the operation history data in facility device DB 41 to the latest operation history data.

Various types of data in the facility device DB are stored for a certain period and discarded after lapse of the certain period. In the example in FIG. 4, operation data E1a, abnormality data E1b, and operation history data E1c are brought in correspondence with the facility device ID labeled as E1. In FIG. 4 and a figure showing a DB which will be described later, “ . . . ” means that description is not repeated. Another type of information may be brought in correspondence with the facility device ID, although it is not shown in FIG. 4. Another type of information includes an address number of each facility device, an operation group number, and the like. For air-conditioner 2A, another type of information includes information on connection of a refrigerant system including an outdoor unit and an indoor unit.

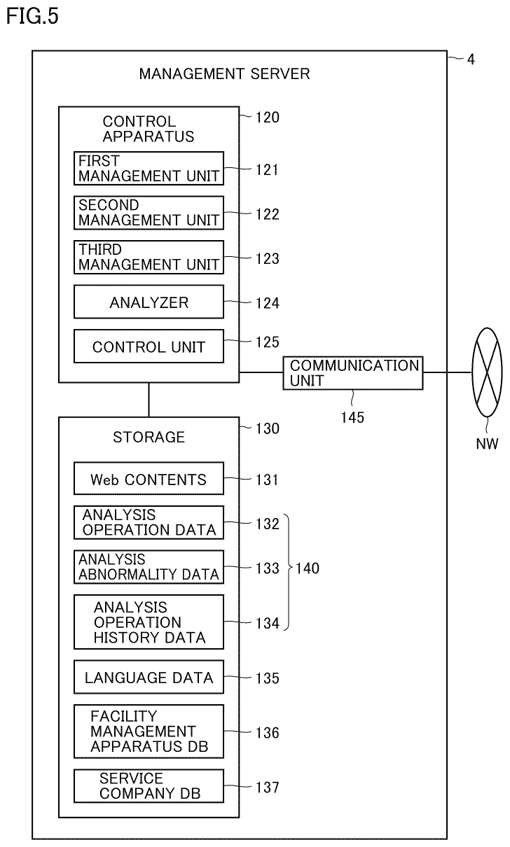

FIG. 5 is a functional block diagram of management server 4. Management server 4 is typically a computer accessible from another apparatus (facility management apparatus 3, user terminal 8, or the like) over the Internet provided on a cloud system or the like. In the example in FIG. 5, management server 4 includes a control apparatus 120, a storage 130, and a communication unit 145. Control apparatus 120 includes a first management unit 121, a second management unit 122, a third management unit 123, an analyzer 124, and a control unit 125. Web contents 131, analysis operation data 132, analysis abnormality data 133, analysis operation history data 134, language data 135, a facility management apparatus DB 136, and a service company DB 137 are stored in storage 130. Management server 4 communicates with another apparatus through communication unit 145.

First management unit 121 receives an abnormality inquiry signal from user terminal 8. First management unit 121 obtains identification information of facility management apparatus 3 included in the abnormality inquiry signal. First management unit 121 establishes connection to facility management apparatus 3 (that is, the identified management apparatus) indicated by the identification information and manages communication of the identified management apparatus. Second management unit 122 manages a state of connection of management server 4 to the Internet to allow communication with facility management apparatus 3, user terminal 8, and service terminal 9.

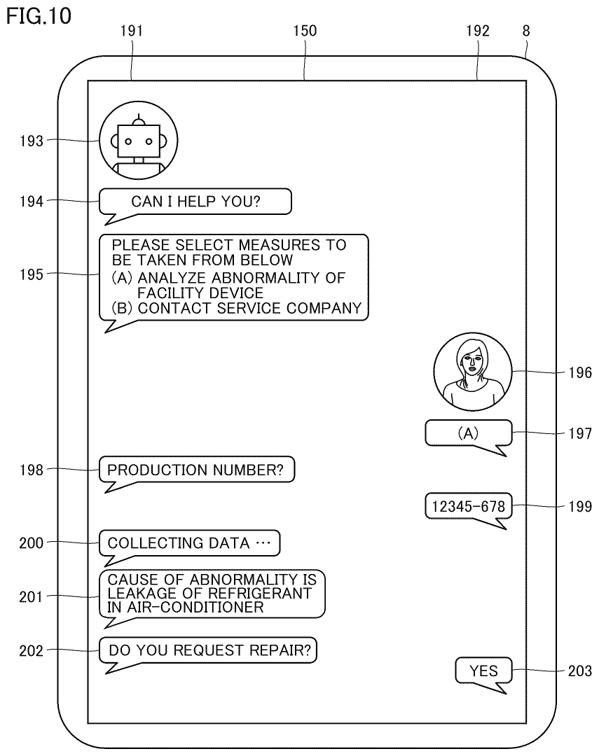

When third management unit 123 receives an abnormality inquiry by a chat (see FIG. 10 or the like which will be described later) from user terminal 8, it analyzes contents of the chat based on language data 135. Language data 135 is character data and grammar data for analysis of meaning of words and sentences received from user terminal 8 and inputted into the chat. Control apparatus 120 analyzes the meaning of the contents inputted by the user based on language data 135 to establish a chat system.

Third management unit 123 determines whether or not analysis by analyzer 124 is necessary and whether or not control by control unit 125 is necessary based on a result of analysis of the contents of the chat. When analysis by analyzer 124 is necessary, third management unit 123 outputs a command signal to analyzer 124. When control by control unit 125 is necessary, third management unit 123 outputs a command signal to control unit 125. Third management unit 123 provides a result of analysis by analyzer 124 and a result of control by control unit 125 as an answer to user terminal 8 through the chat.

Analyzer 124 obtains determination data 140 from the identified management apparatus through first management unit 121. Determination data 140 is data for specifying facility device 2 or the like where abnormality occurs, of at least one facility device 2 managed by the identified management apparatus. Analyzer 124 has determination data 140 once stored in storage 130.

Determination data 140 includes analysis operation data 132, analysis abnormality data 133, and analysis operation history data 134. Analysis operation data 132, analysis abnormality data 133, and analysis operation history data 134 are identical to the operation data, the abnormality data, and the operation history data obtained form the identified management apparatus, respectively.

Analyzer 124 generates the abnormality information by analyzing determination data 140. The facility device where abnormality occurs will also be referred to as an “abnormal facility device” below. The abnormality information is information on the abnormal facility device. The abnormality information includes, for example, the facility device ID of the abnormal facility device. The abnormality information includes whether or not low-load operation (makeshift operation) which will be described later can be performed, a cause of abnormality, a method of overcoming the abnormality, and the like.

In the present embodiment, the abnormality includes first abnormality and second abnormality. The second abnormality is abnormality higher in degree of abnormality than the first abnormality. In other words, the first abnormality is minor abnormality and the second abnormality is severe abnormality.

Analyzer 124 determines whether abnormality of the abnormal facility device falls under the first abnormality or the second abnormality (determines a type of the abnormality) based on determination data 140. For example, when the number of times of exhibition of an abnormality value by the physical quantity in the operation data is small, the number of times of abnormality indicated by the abnormality data is small, and the number of times of operation in the operation history data is small, analyzer 124 determines the abnormality of the abnormal facility device as the first abnormality. Alternatively, when the number of times of exhibition of the abnormality value by the physical quantity in the operation data is large, the number of times of abnormality indicated by the abnormality data is large, and the number of times of operation in the operation history data is large, analyzer 124 determines the abnormality of the abnormal facility device as the second abnormality. When the abnormality indicated by the abnormality data is not exhibited, analyzer 124 determines that there is no abnormality of the abnormal facility device. Any method of determination by analyzer 124 may be applicable, and for example, a method using artificial intelligence (AI) may be applicable.

Analyzer 124 outputs a result of analysis to control unit 125. Control unit 125 transmits a command signal in accordance with the type of the abnormality (one of the first abnormality and the second abnormality) to the identified management apparatus via third management unit 123 and communication unit 145. The command signal includes the facility device ID of the abnormal facility device. The identified management apparatus causes the abnormal facility device to perform operation based on the command signal.

When the abnormality of the abnormal facility device falls under the first abnormality (minor abnormality), control unit 125 transmits the command signal to cause the abnormal facility device to perform the low-load operation to the identified management apparatus. For example, the low-load operation of air-conditioner 2A is air blow operation by the air-conditioner without compressor 2B being driven. The low-load operation of the ventilation device is operation to lower a degree of ventilation (for example, an air volume) than that while the low-load operation is not performed. The low-load operation of the lighting device is operation to lower a degree of lighting (for example, brightness) than that while the low-load operation is not performed.

When the abnormality of the abnormal facility device falls under the second abnormality (severe abnormality), control unit 125 transmits a command signal to stop operations of the abnormal facility device to the identified management apparatus. Furthermore, control unit 125 makes arrangement for a serviceperson who will repair the deactivated abnormal facility device. Specifically, control unit 125 specifies a service company from which the serviceperson is to be dispatched, by referring to facility management apparatus DB 136.

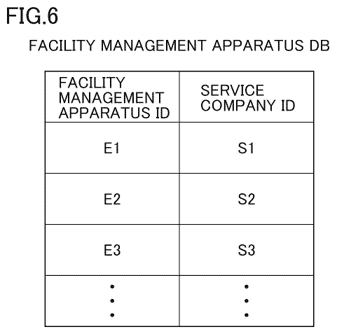

FIG. 6 is a diagram schematically showing an exemplary facility management apparatus DB 136. In the example in FIG. 6, a service company ID is brought in correspondence for each facility management apparatus ID. In the present embodiment, the facility management apparatus ID is brought in correspondence with the service company ID of the service company belonging to an area to which the facility management apparatus indicated by the facility management apparatus ID belongs. Control unit 125 can thus specify the service company located at a location close to the identified management apparatus (that is, the facility management apparatus to manage the abnormal facility device). Furthermore, control unit 125 transmits a request signal to service terminal 9 of the specified service company. The request signal is a signal for request for services of the abnormal facility device.

For facility management apparatus DB 136, information such as a production number, a model number, and a software version of facility management apparatus 3 having the facility management apparatus ID may be brought in correspondence with the facility management apparatus ID. When a configuration for various types of monitoring and control by direct connection of management server 4 to facility management apparatus 3 is adopted, an IP address, a domain name, a host name, or the like of facility management apparatus 3 which is information on a connection target may be brought in correspondence with the facility management apparatus ID.

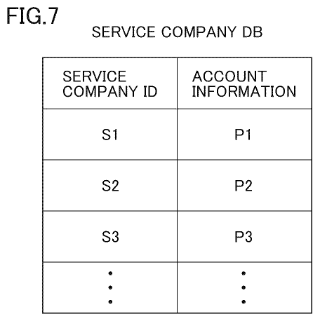

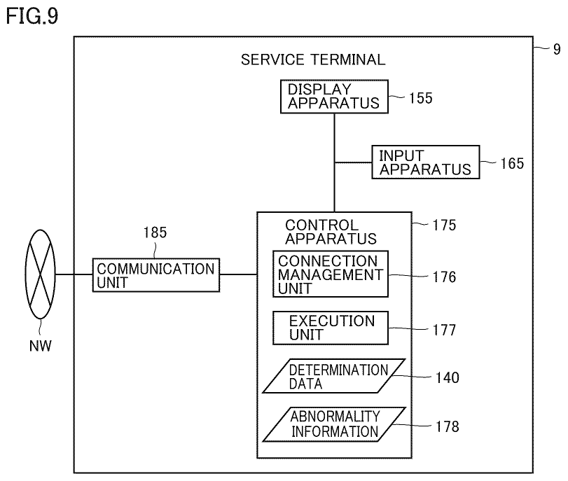

FIG. 7 is a diagram schematically showing an exemplary service company DB 137. In the example in FIG. 7, account information is brought in correspondence for each service company ID. The account information includes a user ID and a password. As will be described later, service terminal 9 can access management server 4 by logging in to management server 4 based on the account information. Service terminal 9 can then obtain determination data 140 of the abnormal facility device to be serviced and abnormality information 178 which is a result of analysis by analyzer 124 (see FIG. 9). Furthermore, display apparatus 155 of service terminal 9 shows an image based on determination data 140 and an image based on abnormality information 178. Therefore, a person in charge in the service company can visually recognize (view on the cloud) these images. “At least one of the image based on determination data 140 and the image based on abnormality information 178” will also be referred to as a “service image” below.

Attribute information of the service company may also be brought in correspondence with the service company ID. The attribute information includes a name, a contact telephone number, a contact mail address, or the like of the service company.

Web contents 131 (chat bot) are contents executed on a web browser of user terminal 8. Management server 4 controls representation or the like in a chat screen (see FIG. 10 or the like) based on web contents 131.

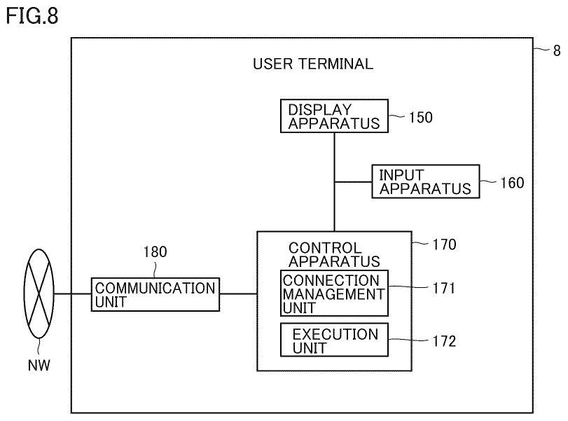

FIG. 8 is a functional block diagram of user terminal 8. User terminal 8 includes a display apparatus 150, an input apparatus 160, a control apparatus 170, and a communication unit 180. Display apparatus 150 shows information from management server 4 (contents of a chat (images, characters, and the like) with management server 4 or the like) or the like. On this screen, the user provides input of a production number of facility management apparatus 3, an instruction for investigation for a factor for abnormality, an instruction to start the low-load operation, or the like.

Input apparatus 160 is an input device. Input apparatus 160 is an apparatus where a software keyboard or the like is shown and a necessary instruction can be selected and inputted in a chat. In the present embodiment, the touch panel is composed of display apparatus 150 and input apparatus 160 as being integrated.

Control apparatus 170 includes a connection management unit 171 and an execution unit 172. Connection management unit 171 manages connection and a state of connection to the Internet. Execution unit 172 executes the web browser.

FIG. 9 is a functional block diagram of service terminal 9. Service terminal 9 includes a display apparatus 155, an input apparatus 165, a control apparatus 175, and a communication unit 185. Display apparatus 155 shows contents of a chat with user terminal 8 or the like, on the web browser executed in service terminal 9.

Input apparatus 165 is an input device. Input apparatus 165 is a keyboard or the like, and it is an apparatus where a necessary instruction can be selected and inputted in a chat. Control apparatus 175 includes a connection management unit 176 and an execution unit 177. Connection management unit 176 manages connection and a state of connection to the Internet. Execution unit 177 executes the web browser. Communication unit 185 communicates with management server 4 and user terminal 8 connected over network NW.

As described above, service terminal 9 can obtain determination data 140 and abnormality information 178 of the abnormal facility device to be serviced. The example in FIG. 9 shows that control apparatus 175 holds determination data 140 and abnormality information 178. Control apparatus 175 controls display apparatus 155 to show, for example, a service image based on determination data 140 and abnormality information 178.

### Chat Screen

FIG. 10 is a diagram for illustrating an exemplary display screen of user terminal 8. In the example in FIG. 10, a display area of display apparatus 150 includes a first display area 191 for management server 4 and a second display area 192 for user terminal 8. An image based on information generated by management server 4 is shown in first display area 191. An image based on information generated by user terminal 8 is shown in second display area 192. As shown in FIG. 10, display apparatus 150 shows in a chat form, an image from management server 4 and an image from user terminal 8.

For example, when the user feels abnormality of the facility device, the user starts up a chat application by performing prescribed start-up operation onto user terminal 8. When the chat application is started up, display apparatus 150 shows an image 193, an image 194, an image 195, and an image 196. Image 193 is an image of a robot imitating management server 4 (computer). In other words, the image shown in first display area 191 is an image based on analysis by management server 4 (computer).

Image 196 is an image imitating the user. Image 194 is a character image “can I help you?” Image 195 includes an image “please select measures to be taken from below” and an image showing choices. The choices include “(A) analyze abnormality of facility device” and “(B) contact service company.”

The user is assumed to have performed operation to designate the choice (A) onto input apparatus 160. As a result of this operation, display apparatus 150 shows an image 197 showing the choice (A). Display apparatus 150 then shows an image 198 to invite input of a production number under the control by management server 4. Image 198 is a character image “production number?”

The user who has visually recognized image 198 performs operation to input the production number onto input apparatus 160. As a result of the operation, display apparatus 150 shows an image 199 showing the inputted production number. FIG. 10 shows an example where the production number shown in image 199 is “12345-678”. User terminal 8 transmits the abnormality inquiry signal including the inputted production number to management server 4 (see the step (A) in FIG. 1).

Management server 4 requests the identified management apparatus to provide the determination data, obtains the determination data of the identified management apparatus, and conducts analysis based on the determination data (see the steps (B) and (C)). Management server 4 shows an image 200 for a time period required for processing in the (steps (B) and (C). Image 200 is an image of characters “collecting data . . . ”

When analysis by management server 4 ends, management server 4 then shows an image 201 showing a cause of abnormality indicated by the result of analysis. In the example in FIG. 10, image 201 is a character image “cause of abnormality is leakage of refrigerant in air-conditioner.” In the present embodiment, abnormality due to leakage of refrigerant in the air-conditioner is assumed to fall under the second abnormality.

In succession, management server 4 shows an image 202 to check whether or not there is a repair request. Image 202 is a character image “do you request repair?” The user who has visually recognized image 202 performs operation indicating whether or not to make repair onto input apparatus 160. User terminal 8 shows an image 203 in accordance with the operation. Image 203 in FIG. 10 is a character image “yes”.

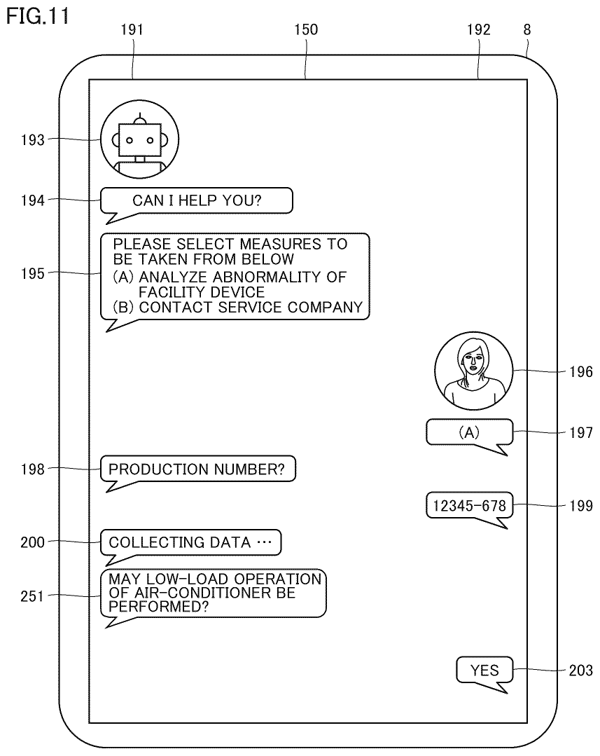

When the abnormality of the abnormal facility device falls under the first abnormality, management server 4 shows an image to check with the user, whether or not to perform the low-load operation described above. FIG. 11 is a diagram for illustrating an image 251 to check with the user, whether or not to perform the low-load operation. In the example in FIG. 11, this image 251 is a character image “is low-load operation of air-conditioner to be performed?” In response, the user inputs whether or not to perform the low-load operation.

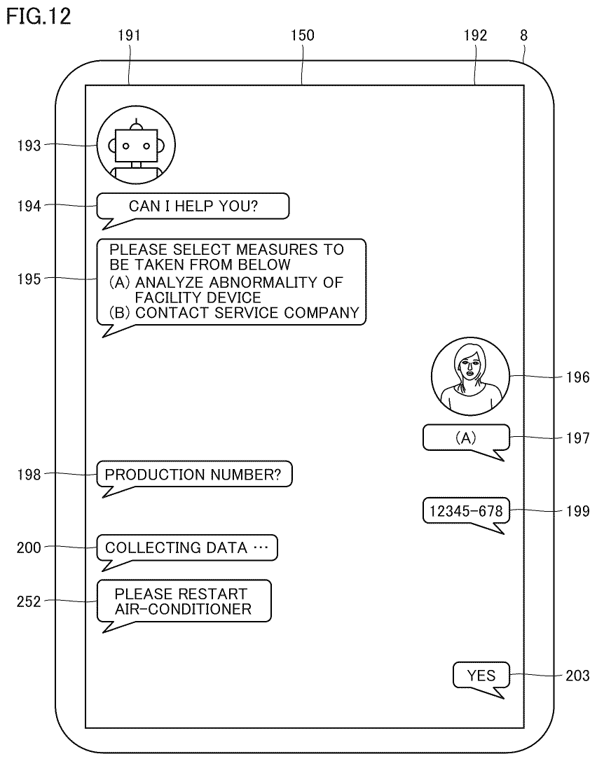

The abnormality of the abnormal facility device may fall, for example, under the first abnormality, and the user himself/herself may be able to overcome the first abnormality. This case refers, for example, to a case where the first abnormality is overcome by restart of the facility device. In this case, management server 4 shows an image showing a method of overcoming the abnormality. FIG. 12 is a diagram for illustrating an image 252 to overcome the abnormality. In the example in FIG. 12, this image 252 is a character image “please restart air-conditioner.” In response, the user can overcome the abnormality of the air-conditioner by restarting the air-conditioner.

When the user has selected a request for repair to the service company, management server 4 (for example, third management unit 123) sets up a service company chat by referring to registration information of the service company stored in service company DB 137. The service company chat is a chat for the request for repair between the service company and the user. Management server 4 shows a uniform resource locator (URL) of the chat in the chat screen of display apparatus 150. Management server 4 transmits the identical URL also to a mail address of the service company registered in service company DB 137. The user and the person in charge in the service company can thus use the chat.

As shown in FIGS. 10 to 12, user terminal 8 shows images (image 197, image 199, and image 203) in accordance with input from the user and images showing the abnormality information in the chat form. In other words, user terminal 8 shows in the identical screen, the image in accordance with input from the user and image 201 showing the abnormality information.

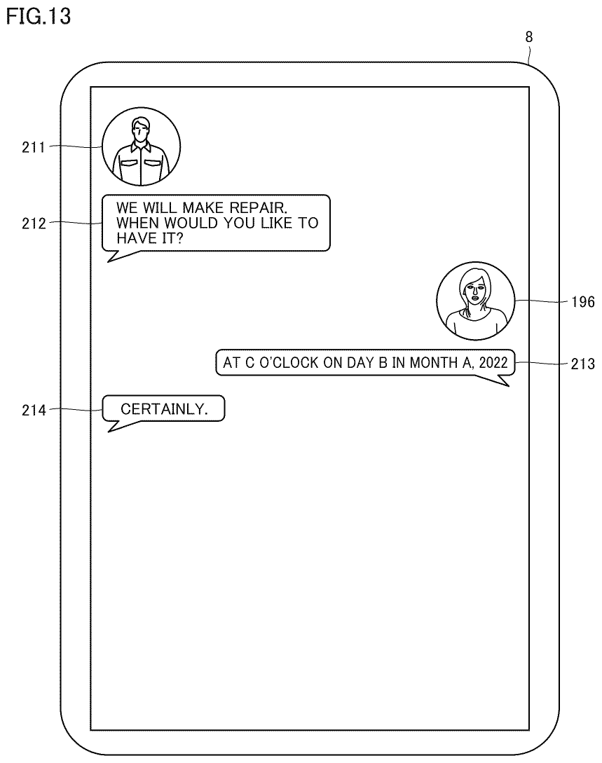

FIG. 13 is a diagram showing an exemplary service company chat. When user terminal 8 accesses the URL of the service company chat, display apparatus 150 shows an image 211, an image 212, and image 196 shown in FIG. 10. Image 211 is an image imitating the serviceperson. Image 212 is an image for inquiry to the user about service start time. Image 212 is a character image “We will make repair. When would you like to have it.” Image 212 may include an image (for example, a calendar) for recognition of the service start time.

The user performs operation to input the service start time desired by the user onto input apparatus 160. In response to this operation, display apparatus 150 shows an image 213 showing the service start time. Image 213 is a character image “at C o'clock on day B in month A, 2022.”

The person in charge in the service company who has visually recognized image 213 performs operation indicating whether or not the services can be performed at the service start time onto input apparatus 165. Display apparatus 150 shows an image 214 in accordance with this operation. Image 214 is a character image “certainly”.

In the chat screens shown in FIGS. 10 to 13, as interactions proceed, the chat screen scrolls. Display apparatus 150 may then erase past comments that cannot fully be shown on the chat screen from the display area of the chat screen. Display apparatus 150 may show contents of the past chat by upward scroll of the screen by the user.

User terminal 8 and service terminal 9 show in the identical screen, the image (image 213) in accordance with input from the user onto user terminal 8 and the image (image 214) in accordance with input by the person in charge (who is also referred to as the user) onto the service terminal.

### Flowchart

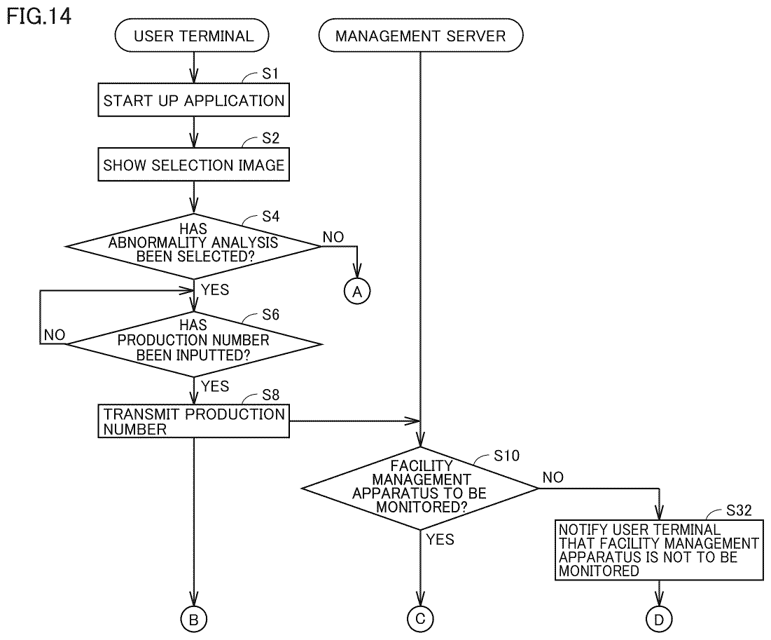

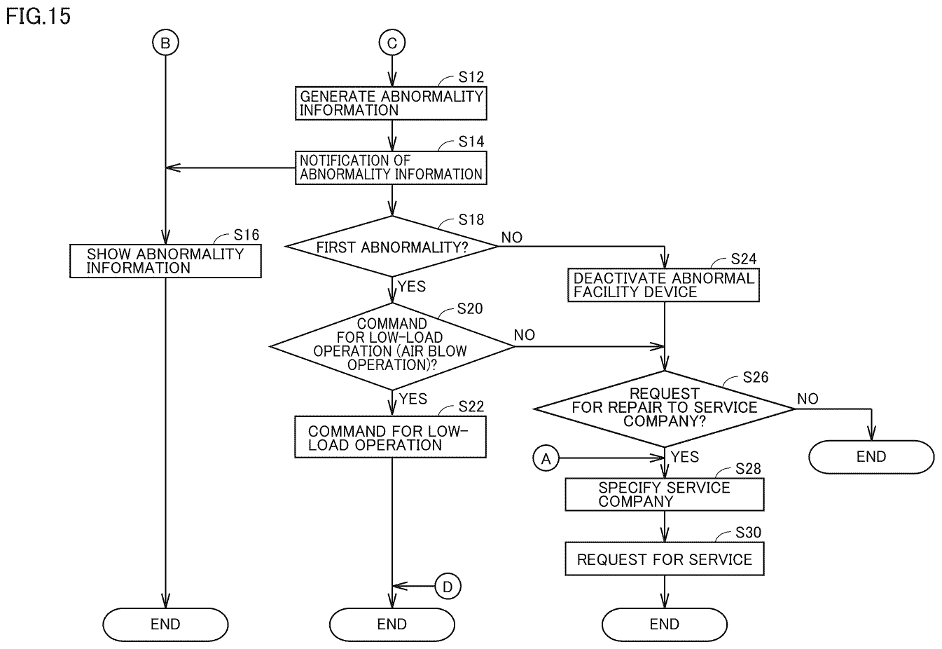

FIGS. 14 and 15 are each a flowchart showing processing mainly in user terminal 8 and management server 4. FIG. 14 shows a former part of the flowchart and FIG. 15 shows a latter part of the flowchart.

Processing in FIG. 14 starts when the user performs the start-up operation described above. In step S1, user terminal 8 starts up the chat application. Then in step S2, user terminal 8 shows a selection image (image 195 in FIG. 10). Then in step S4, user terminal 8 determines whether or not the user has selected “analyze abnormality” which is the choice (A) in the selection image. When abnormality analysis has been selected (YES in step S4), the process proceeds to step S6. Alternatively, when the user has selected “contact service company” which is the choice (B) in step S4 (NO in step S4), the process proceeds to step S28.

In step S6, user terminal 8 determines whether or not the production number bas been inputted. User terminal 8 stands by until the production number is inputted (NO in step S6). When the production number has been inputted, user terminal 8 shows image 199 showing the production number, and transmits the production number to management server 4 in step S8. Processing in step S8 corresponds to the step (A) in FIG. 1.

When management server 4 receives the production number, in step S10, it determines whether or not the facility management apparatus indicated by the production number is the facility management apparatus to be monitored. In other words, management server 4 determines whether or not the facility management apparatus ID corresponding to the production number is defined in the facility management apparatus DB (see FIG. 6). When the facility management apparatus ID is not defined in the facility management apparatus DB (see FIG. 6) (NO in step S10), the process proceeds to step S32. In step S32, management server 4 causes user terminal 8 to provide notification that the facility device corresponding to the production number transmitted by the user is not to be monitored by management server 4.

When the facility management apparatus ID is defined in the facility management apparatus DB (see FIG. 6) (YES in step S10), the process proceeds to step S12. In step S12, management server 4 collects and analyzes the determination data. Management server 4 then generates the abnormality information based on analysis. Then in step S14, management server 4 causes user terminal 8 to provide notification of the abnormality information (see image 201 or the like in FIG. 10), In step S16, user terminal 8 shows the abnormality information in the chat screen.

After processing in step S14, in step S18, management server 4 determines whether or not the abnormality falls under the first abnormality (minor abnormality). When the abnormality falls under the first abnormality (YES in step S20), in step S20, management server 4 determines whether or not to command the low-load operation. As shown in parentheses in step S20, the low-load operation in connection with air-conditioner 2A is the “air blow operation.”

In this step S20, management server 4 has image 251 (see FIG. 11) shown, and determination in accordance with input from the user is made. For example, when the user inputs “yes”, determination as YES is made in step S20, and when the user inputs “no”, determination as NO is made in step S20.

When determination as YES is made in step S20, in step S22, management server 4 causes the abnormal facility device to perform the low-load operation with the identified management apparatus being interposed. The process then ends.

When determination as NO is made in step S18, that is, when the abnormality falls under the second abnormality, in step S24, management server 4 transmits the command signal to deactivate the abnormal facility device to the identified management apparatus. The abnormal facility device thus stops operating. Then in step S26, management server 4 determines whether or not to make a repair request to the service company.

In this step S26, management server 4 has image 202 (see FIG. 10) shown, and determination in accordance with input from the user is made. For example, when the user inputs “yes”, determination as YES is made in step S26, and when the user inputs “no”, determination as NO is made in step S26. When determination as NO is made in step S26, the process ends.

When determination as YES is made in step S26, in step S28, management server 4 specifies the service company by referring to the facility management apparatus DB (see FIG. 6). Then in step S30, management server 4 requests the specified service company to provide services. Specifically, management server 4 transmits the request signal to service terminal 9 of the specified service company. In step S30, management server 4 carries out control in connection with the URL described above for showing the chat screen described with reference to FIG. 13 on user terminal 8 and service terminal 9. After step S30, the process ends. When determination as NO is made in step S20, the process proceeds to step S26.

### Functions and Effects

(1) As set forth above, in the conventional management system, the user in the structure where the management system is provided may feel abnormality of a facility device such as an air-conditioner and may desire to know whether or not there is abnormality of the facility device. The conventional management system, however, may be disadvantageous in that it does not consider such a case.

Then in management system 1 in the present disclosure, as shown in FIG. 1, user terminal 8 transmits the identification information of facility management apparatus 3 to management server 4 in accordance with input from the user (the step (A)). Management server 4 then generates the abnormality information on the abnormal facility device (the steps (B) and (C)) and causes user terminal 8 to provide notification of the abnormality information (the step (D)). Therefore, the user who has grasped the abnormality information provided by user terminal 8 can appropriately recognize the abnormality of the facility device.

In addition, the conventional management system notifies the service terminal of the abnormality information. The serviceperson then recognizes the abnormality of the air conditioner through the notification. Subsequently, the serviceperson visits the structure provided with the air-conditioner where the abnormality has occurred and conducts field investigation to grasp the abnormality of the air-conditioner.

Thereafter, the serviceperson reports to the user about the abnormality of the air-conditioner. Therefore, in the conventional management system, a great amount of time may disadvantageously be required before recognition by the user of the abnormality of the air-conditioner. In addition, cost (wages or the like to be paid to the serviceperson) for the field investigation by the serviceperson may disadvantageously be incurred.

In contrast, in the management system in the present disclosure, management server 4 generates the abnormality information and causes user terminal 8 to provide notification of the abnormality information. Therefore, since the user can recognize the abnormality information without the field investigation by the serviceperson, time required before recognition by the user of the abnormality of the air-conditioner and cost can be reduced.

In the management system in the present disclosure, the abnormality information is generated in accordance with user input to user terminal 8. Therefore, the user can recognize the abnormality information at any timing desired by the user even during non-working hours of the serviceperson. In addition, the user can recognize the abnormality information without knowledge about the facility device.
(2) As shown in FIG. 1, management server 4 obtains the determination data of the abnormal facility device from the identified management apparatus (the step (B)), and generates the abnormality information based on determination data 140 of the abnormal facility device (the step (C)). Therefore, a time period for generation of the abnormality information can be shorter than in an example where the user or the serviceperson collects the determination data in the field investigation.
(3) As shown in FIG. 5, determination data 140 includes at least one of analysis operation data 132, analysis abnormality data 133, and analysis operation history data 134 of the abnormal facility device. Therefore, management server 4 can generate the abnormality information based on at least one of the past operating state of the abnormal facility device, the past abnormal state of the abnormal facility device, and the past operation history of the abnormal facility device.
(4) The abnormality of the abnormal facility device includes the first abnormality and the second abnormality higher in degree of abnormality than the first abnormality. As shown in FIG. 5, control unit 125 of management server 4 transmits the command signal in accordance with the type of the abnormality to the identified management apparatus. In addition, the identified management apparatus causes the abnormal facility device to perform operations based on the command signal. Therefore, management server 4 can cause the abnormal facility device to perform flexible operations in accordance with the type of the abnormality.
(5) As shown in step S22 in FIG. 15, when the abnormality falls under the first abnormality, management server 4 outputs the command signal to cause the abnormal facility device to perform the low-load operation. Therefore, management system 1 can cause the abnormal facility device to operate in a makeshift manner even while the abnormal facility device is waiting for repair. Consequently, management system 1 can lessen lowering in comfort caused by the abnormal facility device.
(6) As shown in the parentheses in step S20 in FIG. 15, the low-load operation in connection with air-conditioner 2A is the “air blow operation.” Therefore, management system 1 can lessen degradation of an air-conditioned environment due to stagnation of air circulation in the structure where air-conditioner 2A is provided.
(7) As shown in step S24 in FIG. 15, when the abnormality falls under the second abnormality, management server 4 outputs the command signal to deactivate the abnormal facility device. Therefore, management system 1 can reduce continuation of operations of the severely abnormal facility device.
(8) As shown in step S30 in FIG. 15, when the abnormality falls under the second abnormality, management server 4 transmits the request signal to request the services for the abnormal facility device to service terminal 9. Therefore, management system 1 can have the service company recognize the abnormal facility device in a state of the second abnormality. Even the user who has not recognized device information of the abnormal facility device can make a request for the services.
(9) As shown in FIG. 9, service terminal 9 obtains at least one of determination data 140 and abnormality information 178 and shows on display apparatus 155, a service image based on the at least one of them. Therefore, the serviceperson can recognize contents of the abnormality of the abnormal facility device before field investigation. Therefore, the serviceperson can make arrangements for defective components, specify a repair method, or the like early.
(10) Management server 4 transmits the request signal to service terminal 9 of the service company belonging to the area to which the identified management apparatus belongs, based on the facility management apparatus DB shown in FIG. 6. Therefore, request for the services can be made to the service company belonging to the area to which the structure provided with the abnormal facility device belongs (that is, the service company located near the structure).
(11) As shown in FIG. 13, user terminal 8 and service terminal 9 show in the identical screen (that is, in the chat form), the image in accordance with input to user terminal 8 and the image in accordance with input to service terminal 9. Therefore, the user and the person in charge in the service company can intuitively recognize the image in accordance with input to user terminal 8 and the image in accordance with input to service terminal 9. In addition, the user and the person in charge in the service company can adjust a schedule of repair or the like and check progress of repair.
(12) As shown in FIGS. 10 to 12, user terminal 8 shows in the identical screen (that is, in the chat form), the image in accordance with input from the user and the abnormality information. Therefore, the user can intuitively recognize the abnormality information.

As shown in FIGS. 10 to 12, image 195 including choices is shown. Therefore, management server 4 can readily recognize information inputted by the user (that is, the choice selected by the user). The user can also readily respond to a question from management server 4.
(13) User terminal 8 is a terminal that can be carried by the user. Therefore, the user can recognize the abnormality information not only from the inside of the structure where the facility device is provided but also from the outside of the structure.
(14) As shown in FIGS. 10 to 12, the abnormality information includes at least one of a cause of abnormality of the abnormal facility device, a method of overcoming the abnormality of the abnormal facility device, and whether or not the low-load operation of the abnormal facility device can be performed. Therefore, the user can recognize at least one of the cause of abnormality of the abnormal facility device, the method of overcoming the abnormality of the abnormal facility device, and whether or not the low-load operation of the abnormal facility device can be performed. In other words, the image based on the abnormality information is image 201, image 251, and image 252.

### Second Embodiment.

Processing for generating the abnormality information and processing for causing user terminal 8 to provide notification of the abnormality information will also collectively be referred to as “abnormality information processing” below. The configuration in which management server 4 serves as the notification apparatus to perform the abnormality information processing is described in the first embodiment. Another apparatus, however, may serve as the notification apparatus. In a second embodiment, a configuration in which facility management apparatus 3 serves as the notification apparatus is adopted.

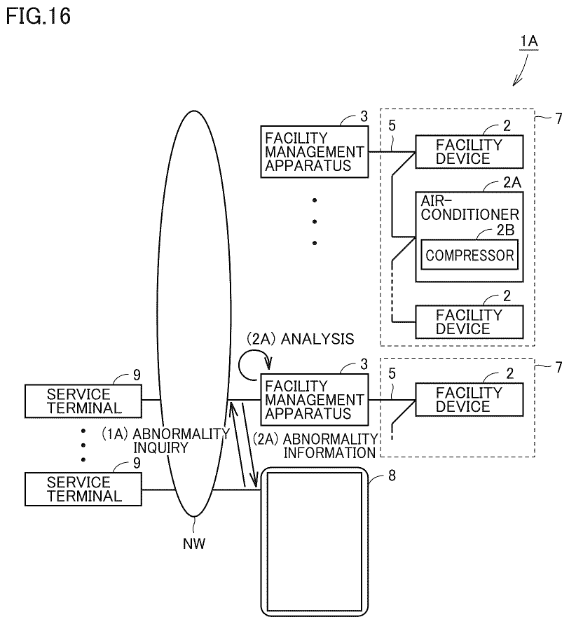

FIG. 16 is an exemplary configuration of a management system 1A in the second embodiment. In the example in FIG. 16, management system 1A does not include management server 4. User terminal 8 in the second embodiment includes a user DB in which a production number (identification information) and a facility management apparatus ID are brought in correspondence with each other.

In the example in FIG. 16, the user terminal transmits a prescribed signal to the facility management apparatus indicated by the identification information designated in accordance with input from the user (step (1A)). The “identification information designated in accordance with input from the user” refers to the facility management apparatus indicated by the facility management apparatus ID brought in correspondence in the user DB with the production number inputted by the user in the user DB. The prescribed signal is, for example, the abnormality inquiry signal. The facility management apparatus that has received the prescribed signal generates the abnormality information by conducting analysis based on determination data (step (2A)). Facility management apparatus 3 then causes user terminal 8 to provide notification of the abnormality information. Such management system 1A in the second embodiment achieves the advantageous effect described above without management server 4.

Alternatively, a configuration in which a system controller or a remote controller serves as the notification apparatus may be adopted. When such a configuration is adopted, these controllers may have an operation menu screen shown to show an image of a notification button in the operation menu screen. A mechanical notification button may be arranged in a housing of these controllers. When the user of facility management apparatus 3 operates the notification button, the notification apparatus transmits the request signal described above to service terminal 9.

### Third Embodiment.

The configuration in which user terminal 8 shows image 195 showing choices and the user selects a desired choice is described in the embodiment described above. User terminal 8, however, may accept text input from the user. User terminal 8 may show image 195 or does not have to show image 195. According to such a configuration, the user can make an inquiry other than the choices. In the present embodiment, information (for example, text) inputted by the user will also be referred to as “input information.”

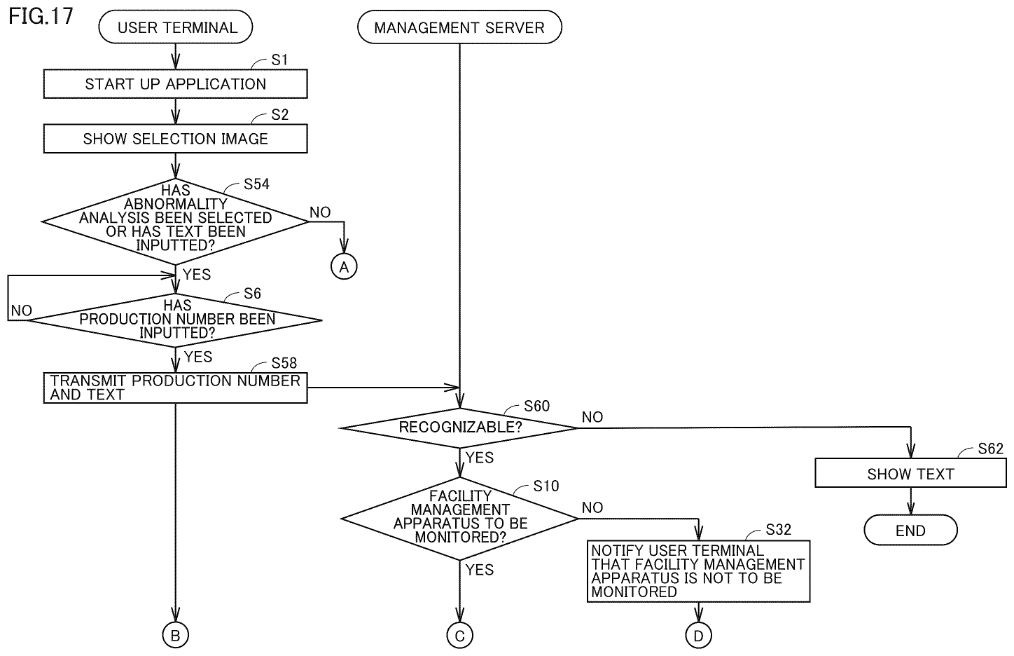

FIG. 17 is a flowchart showing processing mainly in user terminal 8 and management server 4 in a third embodiment. In FIG. 17, step S4 in FIG. 14 is replaced with step S54, step S8 is replaced with step S58, and step S60 and step S62 are added.

In step S54, user terminal 8 determines whether or not abnormality analysis (choice (A)) has been selected or whether or not text input has been provided. When abnormality analysis has been selected or text input has been provided (YES in step S54), the process proceeds to step S6. When abnormality analysis has not been selected or text input has not been provided in step S54, that is, when the user selects “contact service company” which is the choice (B), the process proceeds to step S28.

When determination as YES is made in step S6, the process proceeds to step S58. In step S58, user terminal 8 transmits the production number and inputted text to management server 4. When text has not inputted, that is, abnormality analysis (choice (A)) has been selected, in step S54, in step S58, user terminal 8 does not transmit text but transmits the production number to management server 4.

In step S60, management server 4 determines whether or not transmitted text is recognizable. For example, management server 4 determines whether or not the text is recognizable based on language data 135 described above. When determination as to the text cannot be made (NO in step S60), the process proceeds to step S62. When the text is recognizable (YES in step S60), the process proceeds to step S10.

A case where determination as to the text cannot be made refers to a case where the text is not information on the abnormality of the facility device or a case where grammar or the like of the text is wrong. In this case, in step S62, management server 4 causes a prescribed apparatus to provide notification of the text. In the present embodiment, management server 4 itself is assumed as the prescribed apparatus. In other words, in step S62, management server 4 shows the text (text unrecognizable by management server 4). A manager of management server 4 visually recognizes the text and performs processing in accordance with the text. For example, the manager of management server 4 can convey contents of the shown text to the service company.

A case where determination as to text can be made in step S60 refers to a case where management server 4 was able to extract information on the abnormality of the facility device from the text and a case where abnormality analysis (choice (A)) was selected, For example, in step S60, when text is determined as text “air volume of air-conditioner is low,” determination as YES is made in step S60 assuming that the information on the abnormality of the facility device could be extracted. Thereafter, management server 4 performs processing in step S10 or later to generate the abnormality information.

Thus, in a management method in the present embodiment, the chat application is started up by a prescribed operation (the start-up operation described above) by the user onto user terminal 8 (step S1). When user terminal 8 accepts input information on the facility device including the air-conditioner (YES in step S54), it then transmits the input information to the management apparatus (management server 4) (step S58).

Then in step S60, management server 4 determines whether to generate the abnormality information or to cause the prescribed apparatus (management server 4 in the example in FIG. 17) to provide notification of the input information, in accordance with the input information. When determination as generation of the abnormality information has been made in step S60 (YES in step S60), user terminal 8 provides notification of the abnormality information (step S16 in FIG. 15). When it is determined to cause the prescribed apparatus to provide notification of the input information in step S60, management server 4 causes the prescribed apparatus to provide notification of the input information.

According to the configuration in the third embodiment, text input to user terminal 8 by the user is permitted. Therefore, convenience of the user can be improved. Furthermore, when management server 4 is able to recognize the input information, management server 4 itself generates the abnormality information and hence cost incurred in generation of the abnormality information can be reduced. When management server 4 is unable to recognize the input information, a human can visually recognize the input information and hence the human can be caused to perform processing corresponding to the input information.

### Modification

(1) In the embodiments described above, as shown in FIG. 11 or the like, the configuration in which the user makes the abnormality inquiry (step (A)) on condition that operation to input the production number of the facility management apparatus is performed is described. The condition, however, may be another condition so long as the user provides input to user terminal 8. For example, user terminal 8 may show a button for the abnormality inquiry and the user input may an operation onto the button. When such a configuration is adopted, user terminal 8 outputs the identification information of the facility management apparatus upon detection of the user input. This identification information is set based on operation by the user in setting of the chat application (for example, initial setting). According to such a configuration, user terminal 8 transmits the identification information in accordance with the user input. Therefore, the user can visually recognize the abnormality information without recognition of the identification information of the facility management apparatus.
(2) In the embodiments described above, the configuration in which management server 4 obtains the determination data from the identified management apparatus on condition that it receives the identification information from user terminal 8. The condition, however, may be another condition. For example, another condition may be such a condition as lapse of a prescribed period (for example, ten seconds). Under such a condition, management server 4 obtains the determination data every prescribed period. A management server for which such a configuration is adopted achieves an effect as in the embodiments described above.
(3) In the embodiments described above, the configuration in which facility management apparatus 3 and user terminal 8 are terminals separate from each other is described. A configuration in which facility management apparatus 3 and user terminal 8 are identical, however, may be adopted. In other words, facility management apparatus 3 may be a terminal to which notification of the abnormality information generated by management server 4 is provided. According to such a configuration, the person in charge for facility management apparatus 3 (for example, a manager of a structure where facility management apparatus 3 is provided) can recognize the abnormality information.
(4) In the embodiments described above, the configuration in which service terminal 9 accesses management server 4 to show the service image is described. Management server 4, however, may transmit data for the service image. An address of a destination may be registered in service company DB 137.
(5) In the embodiments described above, the configuration in which service terminal 9 obtains determination data 140 and abnormality information 178 on condition that it accesses management server 4 is described. Another condition, however, may be set as the condition. Another condition may be lapse of a prescribed period (for example, ten seconds), Under such a condition, management server 4 transmits determination data 140 and abnormality information 178 to service terminal 9 every prescribed period. In addition, service terminal 9 is a terminal corresponding to facility management apparatus 3 from which determination data 140 and abnormality information 178 are obtained (see FIG. 6). A management server for which such a configuration is adopted also achieves an effect as in the embodiments described above.
(6) In the embodiments described above, as shown in FIG. 10, the configuration in which choices shown in image 195 are “(A) analyze abnormality of facility device” and “(B) contact service company” is described. Image 195, however, may show other choices. Other choices include, for example, “I would like to know cause because cooling in cooling and heating is poor,” “I would like to know contents of shown abnormality code,” “facility device stops operating soon,” “I would like to see operation history of facility device,” “I would like to check abnormality history,” and the like.
(7) In the embodiments described above, the configuration in which the user's desire is satisfied by allowing the user to select a choice in image 195 in the example in FIG. 10 is described. The user, however, may input the user's desire by input of characters.
(8) The manager of management server 4 or the person in charge in the service company may register the service company in service company DB 137. For example, an area within which each service company can provide services may be registered in service company DB 137 and a name of a branch and contact may be changed for each area.
(9) The configuration in which the chat application in the embodiments described above is an application for detection of the abnormality of the facility device is described. The chat application, however, may be one function incorporated in an air-conditioning application. The air-conditioning application is an application for operation of air-conditioner 2A or monitoring of an operation status of air-conditioner 2A. Information on the air-conditioner may be registered in advance in the air-conditioning application. In this case, a configuration in which an air-conditioner of interest may be specified based on information on the air-conditioner and input of the identification information by the user is omitted may be adopted. In such a configuration, the user performs prescribed operation onto user terminal 8 to transmit the identification information of the facility management apparatus.
(10) In the embodiments described above, the configuration in which the service company chat in FIG. 13 is established when “(B) contact service company” in image 195 in FIG. 10 is selected is described. When “(B) contact service company” is selected, however, one of “establish service company chat” in FIG. 13 and “call service company” may be selected. According to such a configuration, convenience of the user can be improved.
(11) As image 198 in FIG. 10 is shown, the user recognizes that input of the production number is to be provided. The user, however, may not know the production number. In view of this case, when a prescribed condition is satisfied, user terminal 8 may show support information for support of recognition of the production number by the user. The prescribed condition may include such a condition as lapse of a prescribed time period since image 198 was shown. Alternatively, the prescribed condition may include such a condition that the user provides prescribed input (for example, input of characters such as “I don't know” or the like). The support information may be, for example, a character image “when indoor unit is provided with two-dimensional code, please read code with camera.” Alternatively, the support information may be a character image “when you can operate remote controller, please perform prescribed operation to input number shown on this remote controller.” Alternatively, the support information may be a character image “please input structure, floor, etc.”
(12) FIG. 10 shows the configuration in which image 201 showing the cause of the abnormality is shown. User terminal 8 may further show abnormality-associated information associated with the abnormality, together with image 201. The abnormality-associated information is, for example, information on a reason why management server 4 has determined that there is such abnormality and information indicating what will happen if the facility device where abnormality has occurred is kept used without being repaired.
(13) FIG. 11 shows the example in which image 251 to invite the low-load operation of air-conditioner 2A is shown as image 251. Even when the low-load operation of air-conditioner 2A is performed, air-conditioner 2A does not fully recover. Therefore, user terminal 8 may show an image for an inquiry to the user about whether or not to request the serviceperson for repair, together with image 251.
(14) In the embodiments described above, when determination as YES is made in step S26 (determination as repair by the serviceperson is made), user terminal 8 shows the image of the service company chat in FIG. 13. Even when the image of such a service company chat is shown, however, the serviceperson may not recognize this image. In this case, the user may be kept waiting. Then, when any processing after processing in step S2 or later in FIG. 14 is performed, management server 4 may transmit a signal to the effect that the processing has been started to service terminal 9. According to such a configuration, the serviceperson or the like can recognize in advance that the image of the service company chat in FIG. 13 may be shown. Therefore, occurrence of such an event as the user being kept waiting can be reduced.
(15) The chat screen in FIGS. 10 to 13 may be shown on another apparatus. Another apparatus is, for example, management server 4. According to such a configuration, a person in charge (for example, an operator) for another apparatus can participate in the chat as an observer,

It should be understood that the embodiments disclosed herein are illustrative and non-restrictive in every respect. The scope of the present disclosure is defined by the terms of the claims rather than the description above and is intended to include any modifications within the scope and meaning equivalent to the terms of the claims.

### REFERENCE SIGNS LIST

1, 1A management system; 2 facility device; 2A air-conditioner; 2B compressor; 3 facility management apparatus; 4 management server; 5 dedicated communication line; 7 facility device group; 8 user terminal; 9 service terminal; 10, 150, 155 display apparatus; 20, 160, 165 input apparatus; 30, 120, 170, 175 control apparatus; 31, 121 first management unit; 32, 122 second management unit; 33, 123 third management unit; 34 fourth management unit; 40, 130 storage; 50, 60, 145, 180, 185 communication unit; 92 ROM; 93 RAM; 124 analyzer; 125 control unit; 132 analysis operation data; 133 analysis abnormality data; 134 analysis operation history data; 135 language data; 140 determination data; 171, 176 connection management unit; 172, 177 execution unit; 191 first display area; 192 second display area.

1. A management system comprising:
first management apparatuses, each first management apparatus managing a facility device comprising at least one air-conditioner; and
a second management apparatus to communicate with the first management apparatuses and a user terminal to accept input from a user, wherein
the user terminal is configured to transmit identification information of the first management apparatuses to the second management apparatus in response to the input from the user, and
the second management apparatus is configured to
generate abnormality information on an abnormal facility device among facility devices each comprising the at least one air-conditioner managed by an identified management apparatus indicated by the identification information, and
cause the user terminal to provide notification of the abnormality information
the user terminal is configured to show in one screen, the abnormality information and an image in accordance with the input from the user.

2. The management system according to claim 1, wherein
the second management apparatus is configured to
obtain determination data of the abnormal facility device from the identified management apparatus when the second management apparatus receives the identification information, and
generate the abnormality information based on the determination data.

3. The management system according to claim 2, wherein
the determination data comprises at least one of operation data of the abnormal facility device, abnormality data of the abnormal facility device, and operation history data of the abnormal facility device.

4. The management system according to claim 1, wherein
abnormality of the abnormal facility device comprises first abnormality and second abnormality higher in degree of abnormality than the first abnormality,
the second management apparatus is configured to transmit a command signal in accordance with a type of the abnormality to the identified management apparatus, and
the identified management apparatus is configured to cause the abnormal facility device to perform operation based on the command signal.

5. The management system according to claim 4, wherein
when the abnormality falls under the first abnormality, the second management apparatus transmits to the abnormal facility device, the command signal to cause the abnormal facility device to perform low-load operation.

6. The management system according to claim 5, wherein
the low-load operation is air blow operation performed without a compressor of the air-conditioner being driven.

7. The management system according to claim 4, wherein
when the abnormality falls under the second abnormality, the second management apparatus transmits the command signal to deactivate the abnormal facility device.

8. The management system according to claim 1, further comprising a service terminal relating to services of the abnormal facility device, wherein
the second management apparatus is configured to transmit a request signal to request the services of the abnormal facility device to the service terminal.

9. The management system according to claim 8, wherein
the service terminal is configured to provide notification of at least one of an image based on the abnormality information and an image based on determination data for determination as to abnormality of the abnormal facility device.

10. The management system according to claim 8, wherein
the second management apparatus is configured to transmit the request signal to the service terminal of a service company belonging to an area to which the identified management apparatus belongs.

11. The management system according to claim 8, wherein
the user terminal and the service terminal are configured to show in one screen, an image in accordance with input to the user terminal and an image in accordance with input to the service terminal.

12. A management system comprising:
management apparatuses, each management apparatus managing a facility device comprising at least one air-conditioner, wherein
the management apparatus is configured to communicate with a user terminal to accept input from a user,
the user terminal is configured to transmit a prescribed signal to the management apparatus indicated by identification information designated in accordance with the input from the user, and
the management apparatus that has received the prescribed signal is configured to
obtain abnormality information on an abnormal facility device of at least one facility device managed by the management apparatus, and
cause the user terminal to provide notification of the abnormality information
the user terminal is configured to show in one screen, the abnormality information and an image in accordance with the input from the user.

13. (canceled)

14. The management system according to claim 1, wherein
the user terminal is a terminal that can be carried by the user.

15. The management system according to claim 1, wherein
the abnormality information comprises at least one of a cause of abnormality of the abnormal facility device, a method of overcoming the abnormality, and whether low-load operation of the abnormal facility device can be performed.

16. (canceled)

17. A management method comprising:
transmitting, by a user terminal, when the user terminal accepts input from a user, identification information of any management apparatus of management apparatuses each managing a facility device comprising at least one air-conditioner; and
showing in one screen, by the user terminal, an image in accordance with the input from the user and notification of abnormality information on an abnormal facility device among facility devices each comprising the at least one air-conditioner managed by an identified management apparatus indicated by the identification information.

18. (canceled)

19. (canceled)
